(19) United States
(12) Patent Application Publication
(10) Pub. No.: US 2009/0077538 A1
(43) Pub. Date: Mar. 19, 2009

(54) METHODS FOR TESTING SOFTWARE USING ORTHOGONAL ARRAYS

(76) Inventor: Michael Paul Keyes, Austin, TX (US)

Correspondence Address: BROOKS KUSHMAN P.C. / SUN / STK, 1000 TOWN CENTER, TWENTY-SECOND FLOOR, SOUTHFIELD, MI, 48075-1238, US

(21) Appl. No.: 11/856,896

(22) Filed: Sep. 18, 2007

(51) Int. Cl. G06F 11/36

(52) U.S. Cl. 717/124

(57) ABSTRACT

Software code is test using orthogonal array designs. A combination parameter is assigned a value. An ancillary parameter is assigned a value based on a metric for the ancillary parameter. The metric may indicate a number of lines of code executed for the value of the parameter. The metric may indicate a number of objects instantiated for the value of the parameter.

### BACKGROUND

1. Field of the Invention

The invention relates to methods for testing software using orthogonal arrays.

2. Discussion

Software is typically executed with various inputs to evaluate its performance. These inputs may take the form of parameter values that are passed into the software from a command line or from fields in a browser page. Example string parameter values include “http,” “ftp” and “ldap.” Example numerical parameter values includes “0,” “5” and “20.”

Exhaustive testing involves testing all combinations of all chosen values for all parameters. For example, software having 5 parameters, each with 3 values, would yield 3⁵ or 243 total test cases. Exhaustive testing, however, may yield too many test cases. For example, software having 20 parameters, each with 3 values, would yield 3²⁰ or almost 3.5 billion test cases.

Statistical test designs, such as orthogonal arrays, may reduce the number of test cases. Orthogonal arrays combine a set of software parameters into two subsets. One subset may be called the “combination parameters.” The second subset may be called the “ancillary parameters.” The combination parameters are exhaustively tested. The ancillary parameters are not exhaustively tested.

As an example, suppose there are five parameters generically named “A,” “B,” “C,” “D” and “E.” Suppose further that each parameter can take on one of 3 values: “1,” “2” and “3.” With orthogonal array designs, parameters are typically grouped as pairs. In this example, there will be five pairs, “A-B,” “B-C,” “C-D,” “D-E” and “A-E.” Each set of pairs are in turn considered combination parameters to create a set of test cases.

Consider the test cases for the “A-B” pair. The combination parameters are “A” and “B,” and the ancillary parameters are “C,” “D” and “E.” Exhaustive testing for “A” and “B,” both of which have three possible values, will yield 3², or 9, test cases. Values are assigned to the ancillary parameters, “C,” “D” and “E,” randomly or based on experience. The resulting 9 test cases are shown in the following table.

| | |
|---|---|
| COMBINATION | ANCILLARY |

| A | B | C | D | E |
|---|---|---|---|---|
| 1 | 1 | 1 | 2 | 3 |
| 1 | 2 | 2 | 3 | 1 |
| 1 | 3 | 3 | 1 | 2 |
| 2 | 1 | 1 | 2 | 3 |
| 2 | 2 | 2 | 3 | 1 |
| 2 | 3 | 3 | 1 | 2 |
| 3 | 1 | 1 | 2 | 3 |
| 3 | 2 | 2 | 3 | 1 |
| 3 | 3 | 3 | 1 | 2 |

The process is repeated for the “B-C” pair. The combination parameters are “B” and “C,” and the ancillary parameters are “A,” “D” and “E.” Again, there will be 3², or 9, test cases. The process is also repeated for the “C-D,” “D-E” and “A-E” pairs. The orthogonal design results in 5×9, or 45, test cases. Exhaustive testing would result in 3⁵, or 243 test cases.

### SUMMARY

Software code is tested using orthogonal array designs. A combination parameter is assigned a value. An ancillary parameter is assigned a value based on a metric for the ancillary parameter. As disclosed, the metric may indicate a number of lines of code executed for the value of the parameter or a number of objects instantiated for the value of the parameter. The metric may also indicate a number of classes invoked for the value of the parameter or a number of methods invoked for the value of the parameter.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a flow chart of a strategy for testing software according to certain embodiments of the invention.

FIG. 2 is a flow chart of a strategy for selecting a value for an ancillary parameter according to certain embodiments of the invention.

FIG. 3 is another flow chart of a strategy for selecting a value for an ancillary parameter according to certain embodiments of the invention.

FIG. 4 is an exemplary histogram illustrating the code coverage for a value of a parameter according to certain embodiments of the invention.

FIG. 5 is another exemplary histogram illustrating the code coverage for another value of the parameter of FIG. 4.

FIG. 6 is yet another exemplary histogram illustrating the code coverage for yet another value of the parameter of FIG. 4.

### DETAILED DESCRIPTION

One problem with conventional orthogonal array designs is that frequently the number of test cases, while reduced from those for exhaustive testing, is still far too great for available time and resources. In this situation, compromises may be made in testing the quality of the software by simply not running certain test cases that would be required under the conventional orthogonal array designs.

Another problem with conventional orthogonal array designs is that the values for the ancillary parameters are taken as equally important. For example, values may be assigned to the ancillary parameters such that the range of values is equally covered for all ancillary parameters across the test cases. The values for the ancillary parameters, however, often do not have equal importance.

Different values for an ancillary parameter may use the exact same execution lines of code in the software being tested. For example, when the values of an ancillary parameter are numerical, the execution lines of code may be the same for different values. This is particularly true when the execution code simply performs mathematical operations with the values. Different values for ancillary parameters may also result in different execution lines of code in the software being tested. For example, when the execution lines of code have a case statement based on the values for the ancillary parameters, the execution lines of code may be different for different values.

Current statistical test designs do not address the above problems adequately. For example, values of the ancillary parameters may be chosen manually. The combinations of combination parameters and ancillary parameters that the individual tester deems important are also chosen manually. This approach may be expensive and time consuming. As another example, values of the ancillary parameters may be chosen randomly. The combinations of combination parameters and ancillary parameters are also chosen randomly. This approach may not ensure a thorough and competent testing of the software under consideration.

Techniques are disclosed for automatically choosing values of ancillary parameters in orthogonal array experimental designs based on a weighting. For example, an evaluation is made based on the number of different lines of code that each value for each ancillary parameter executes in the software package. The values for the parameters used in testing the software are then chosen based on these evaluations. This results in software that is tested more thoroughly with fewer test cases and with fewer resources consumed than would be required with conventional orthogonal array designs or exhaustive testing.

In one example, a histogram is created. The histogram is based on the different lines of code that are executed for each value of each parameter. The values for the ancillary parameters that execute more lines of code are assigned a higher weighting. Those values with higher weightings are given higher priority to be assigned to the ancillary parameters.

In another example, a tally is created. The tally is based on the number of different objects instantiated for each value of each parameter. The values for the ancillary parameters that result in more instantiated objects are given a higher weighting. Those values with higher weightings are given higher priority to be assigned to the ancillary parameters. Similar tallies may be generated for the number of different classes or methods invoked.

The evaluations that determine the code coverage for the values of the ancillary parameters may be done automatically with conventional testing software designed for this function, as is known to those skilled in the art. Such software keeps a count of, for example, the number of lines of code executed for a value of a parameter.

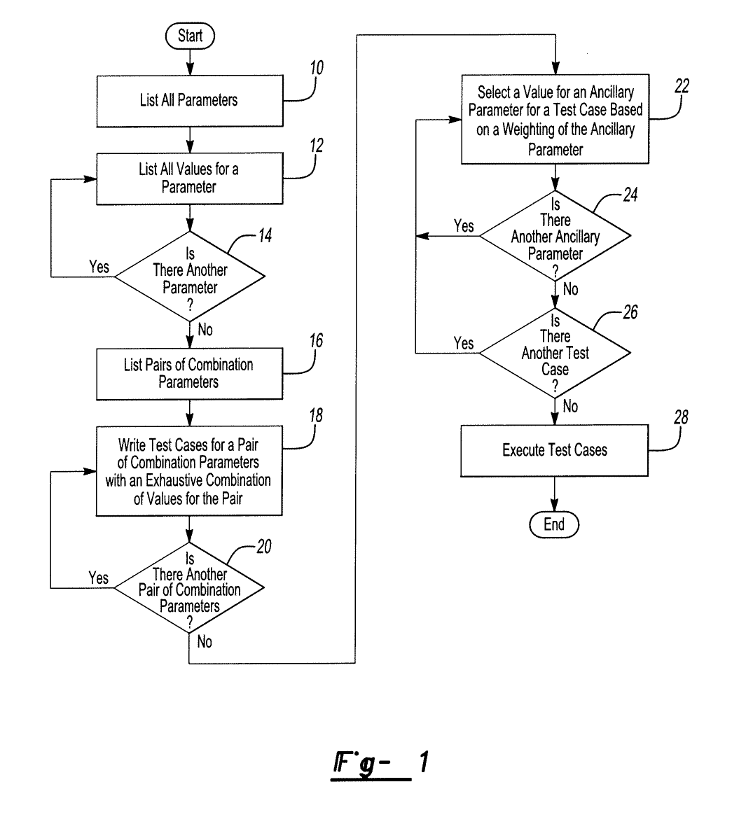

As may be seen in FIG. 1, a strategy for testing software is illustrated in flow chart form. At block 10, all parameters are listed. At block 12, all values for a parameter are listed. At block 14, it is determined whether there is another parameter. If yes, the strategy returns to block 12. If no, at block 16, pairs of combination parameters are listed. At block 18, test cases are written for a pair of combination parameters with an exhaustive combination of values for the pair. At block 20, it is determined whether there is another pair of combination parameters. If yes, the strategy returns to block 18. If no, at block 22, a value for an ancillary parameter is selected for a test case based on a weighting of the ancillary parameter. At block 24, it is determined whether there is another ancillary parameter. If yes, the strategy returns to block 22. If no, at block 26, it is determined whether there is another test case. If yes, the strategy returns to block 22. If no, at block 28, the test cases are executed.

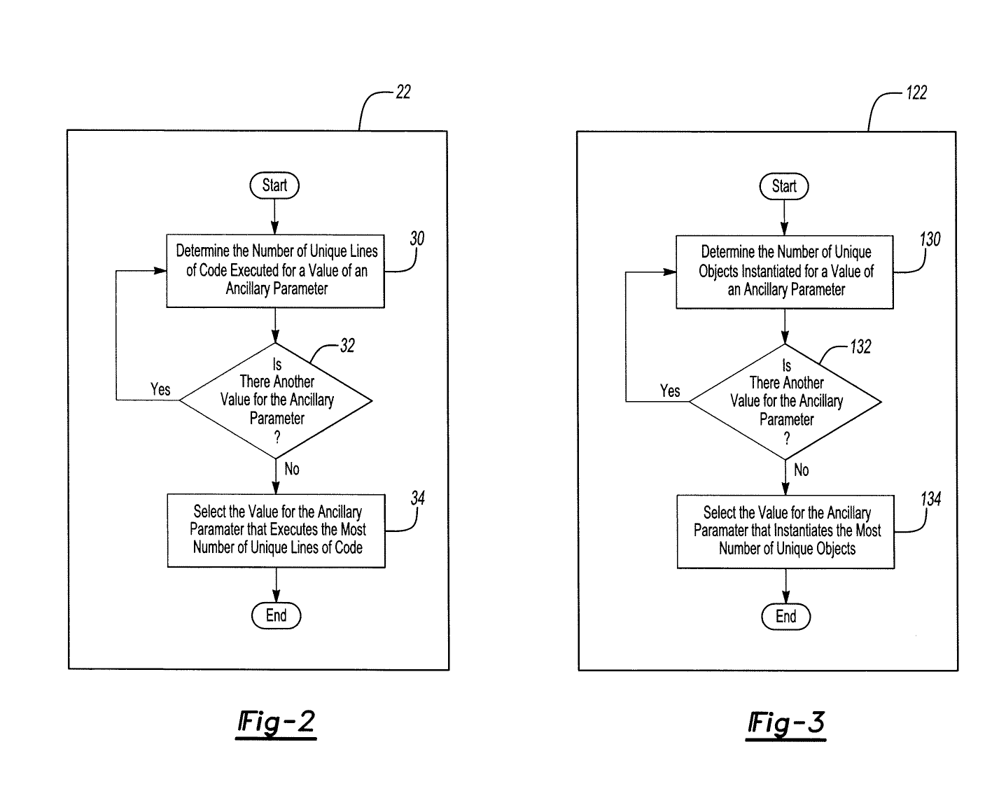

As may be seen in FIG. 2, a strategy 22 for selecting a value for an ancillary parameter is illustrated in flow chart form. At block 30, the number of unique lines of code executed for a value of an ancillary parameter is determined. At block 32, it is determined whether there is another value for the ancillary parameter. If yes, the strategy 22 returns to block 30. If no, at block 34, the value for the ancillary parameter that executes the most number of unique lines of code is selected.

As may be seen in FIG. 3, a strategy 122 for selecting a value for an ancillary parameter based on a weighting of the ancillary parameter is illustrated in flow chart form. Numbered elements of FIG. 3 differing by 100 relative to FIGS. 1-2 have similar, although not necessarily identical, descriptions to the numbers elements of FIG. 1-2. At block 130, the number of different objects instantiated for a value of an ancillary parameter is determined. At block 132, it is determined whether there is another value for the ancillary parameter. If yes, the strategy 122 returns to block 130. If no, at block 134, the value for the ancillary parameter that results in the instantiation of the most different number of objects is selected.

As an example of the techniques disclosed herein, consider again test cases for the “A-B” pair of parameters discussed in the Background. The combination parameters are “A” and “B,” and the ancillary parameters are “C,” “D” and “E.” Exhaustive testing for “A” and “B,” both of which have three possible values, will yield 3², or 9, test cases. Values are assigned to the ancillary parameters, “C,” “D” and “E” using techniques described herein. For the purposes of this example, assume that parameters “A,” “B,” “C,” “D” and “E” have no interaction with each other.

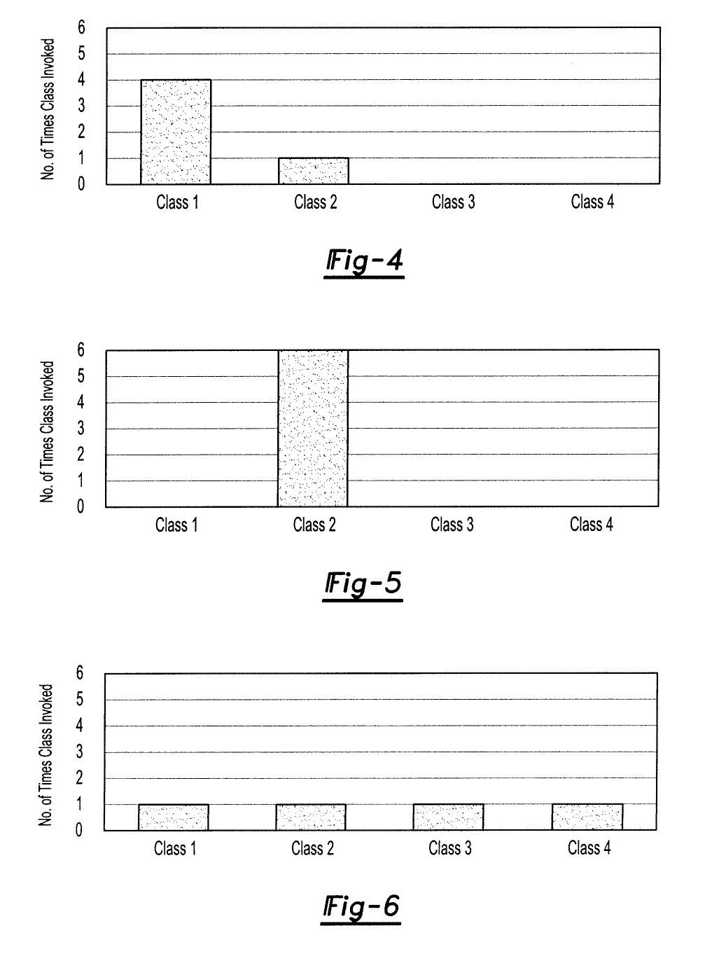

The code coverage is determined for each of the ancillary parameters. FIGS. 4, 5 and 6 are histograms of the code coverage for parameter “C.” The histogram of FIG. 4 reveals that, for a value of “1,” parameter “C” invokes “Class 1” four times and “Class 2” two times. The histogram of FIG. 5 reveals that, for a value of “2,” parameter “C” invokes “Class 2” six times. The histogram of FIG. 6 reveals that, for a value of “3,” parameter “C” invokes “Class 1,” “Class 2,” “Class 3” and “Class 4” each one time. Because a value of “3” for parameter “C” invokes the most different number of classes, “3” will be used as the value for parameter “C” in the test cases.

In cases where the values for the ancillary parameters are selected automatically, the values for the ancillary parameters are selected based on an analysis of the tallies or histograms without manual intervention by, for example, an engineer. In one implementation, a separate computer program collects and analyzes the parameter metrics. This program then assigns values to the ancillary parameters for use in the normal test cycle of the software. Other implementations are also possible.

When determining the code coverage for a parameter, the other parameters should be held constant. For example, the values for parameters “A,” “B,” “D” and “E” are held constant as the value for parameter “C” is varied. While the values of the other parameters may influence the absolute number of classes invoked, the relative difference in the number of classes invoked for different values of the parameter “C” should be unchanged.

Similar evaluations are made for ancillary parameters “D” and “E.” Assuming the results of these evaluations reveal that a value of “2” for parameter “D” invokes the most different number of classes and a value of “2” for parameter “E” invokes the most different number of classes, the resulting 9 test cases for the “A-B” pair are shown in the following table.

| | |
|---|---|
| COMBINATION | ANCILLARY |

| A | B | C | D | E |
|---|---|---|---|---|
| 1 | 1 | 3 | 2 | 2 |
| 1 | 2 | 3 | 2 | 2 |
| 1 | 3 | 3 | 2 | 2 |
| 2 | 1 | 3 | 2 | 2 |
| 2 | 2 | 3 | 2 | 2 |
| 2 | 3 | 3 | 2 | 2 |
| 3 | 1 | 3 | 2 | 2 |
| 3 | 2 | 3 | 2 | 2 |
| 3 | 3 | 3 | 2 | 2 |

The process is repeated for the “B-C” pair of parameters. The combination parameters are “B” and “C,” and the ancillary parameters are “A,” “D” and “E.” Again, there will be 3², or 9, test cases. The process is also repeated for the “C-D,” “D-E” and “A-E” pairs. The orthogonal design still results in 5×9, or 45, test cases. This orthogonal design, however, will test more of the code relative to the orthogonal design discussed in the Background because the values selected for the ancillary parameters for each test case invoke more classes than those selected by experience or at random. Furthermore, only one combination of ancillary parameters needs to be identified because the parameters “A,” “B,” “C,” “D” and “E” have no interaction with each other.

As another example of the techniques disclosed herein, consider again test cases for the “A-B” pair of parameters. Values are assigned to the ancillary parameters, “C,” “D” and “E” using techniques described herein. For the purposes of this example, however, assume that parameters “A” and “B” have some interaction with parameters “C,” “D” and “E.”

The code coverage is again determined for each of the ancillary parameters. Because the combination parameters “A” and “B” have some interaction with each of the ancillary parameters “C,” “D” and “E,” however, the code coverage for each ancillary parameter should be determined for each pair of values that parameters “A” and “B” may assume. For example, for the pair of values “1-1,” the value for parameter “C” that invokes the most different number of classes may be “1.” For the pair of values “1-2,” the value for parameter “C” that invokes the most different number of classes may be “2.” As such, each test case for the combination pair “A-B” may yield a different set of values for the ancillary parameters that has the greatest code coverage. Assuming each parameter's code coverage is evaluated for each test case, the resulting 9 test cases for the “A-B” pair are shown in the following table.

| | |
|---|---|
| COMBINATION | ANCILLARY |

| A | B | C | D | E |
|---|---|---|---|---|
| 1 | 1 | 3 | 2 | 2 |
| 1 | 2 | 3 | 1 | 3 |
| 1 | 3 | 1 | 2 | 2 |
| 2 | 1 | 3 | 2 | 2 |
| 2 | 2 | 3 | 3 | 3 |
| 2 | 3 | 3 | 2 | 2 |
| 3 | 1 | 1 | 2 | 2 |
| 3 | 2 | 1 | 3 | 2 |
| 3 | 3 | 3 | 2 | 2 |

The process described above may be iteratively performed to determine the extent parameter interaction affects code coverage. As an example, suppose that when initially determining the code coverage for parameter “C” for a “1-1” pair of values for parameters “A-B,” “3” and “2” are respectively used as values for parameters “D” and “E.” Further suppose that when subsequently determining the code coverage for parameters “D” and “E,” it is found that the values “1” and “1” for parameters “D” and “E” respectively yield the maximum code coverage. The code coverage for parameter “C” may then be re-evaluated using the values “1” and “1” for parameters “D” and “E” respectively instead of the values “3” and “2” respectively.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for testing software code using a generally orthogonal array of combination and ancillary parameters wherein the combination parameters are exhaustively tested and the ancillary parameters are assigned selective values, the method comprising:
selecting a value for each combination parameter;
establishing a measured weighting of each of the ancillary parameters;
selecting a value for each ancillary parameter based on the measured weightings of the ancillary parameters; and
executing the software using the selected values for the combination and ancillary parameters, thereby testing the software using orthogonal array design.

2. The method of claim 1 wherein the measured weighting for a particular ancillary parameter is based on a number of different lines of code executed for the value of the ancillary parameter.

3. The method of claim 1 wherein the measured weighting for a particular ancillary parameter is based on a number of different objects instantiated for the value of the ancillary parameter.

4. The method of claim 1 wherein the measured weighting for a particular ancillary parameter is based on a number of different methods invoked for the value of the ancillary parameter.

5. The method of claim 1 wherein the measured weighting for a particular ancillary parameter is based on a number of different classes invoked for the value of the ancillary parameter.

6. The method of claim 1 wherein the values for the ancillary parameters are selected automatically.

7. A method for testing software code having parameters using orthogonal array design, the method comprising:
selecting a combination parameter;
assigning a value to the combination parameter;
selecting an ancillary parameter;
assigning a value to the ancillary parameter based on a measure of the code implicated by the ancillary parameter; and
executing the software using the selected values for the combination parameter and the ancillary parameter, thereby testing the software using orthogonal array design.

8. The method of claim 7 wherein the measure comprises a number of different lines of code executed for the value of the ancillary parameter.

9. The method of claim 7 wherein the measure comprises the number of different objects instantiated for the value of the ancillary parameter.

10. The method of claim 7 wherein the measure comprises the number of different methods invoked for the value of the ancillary parameter.

11. The method of claim 7 wherein the measure comprises the number of different classes invoked for the value of the ancillary parameter.

12. The method of claim 7 wherein the values for the ancillary parameters are automatically assigned.

13. A method for creating a test case for software code having parameters using orthogonal array design wherein a set of parameters forms a generally orthogonal array of combination parameters and ancillary parameters, the method comprising:
selecting a value for each of the combination parameters;
determining a metric for each of the ancillary parameters wherein the metric quantifies the amount code affected by values of a parameter;
selecting a value for each of the ancillary parameters based on the metric, thereby creating a test case for software code having parameters using orthogonal array design; and
executing the test case.

14. The method of claim 13 wherein the metric comprises a number of different lines of code executed for the value of the ancillary parameter.

15. The method of claim 13 wherein the metric comprises a number of different objects instantiated for the value of the ancillary parameter.

16. The method of claim 13 wherein the metric comprises a number of different methods invoked for the value of the ancillary parameter.

17. The method of claim 13 wherein the metric comprises a number of different classes invoked for the value of the ancillary parameter.

18. The method of claim 13 wherein the value for each ancillary parameter is selected automatically.
